(19) United States
(12) Patent Application Publication
(10) Pub. No.: US 2025/0244814 A1
(43) Pub. Date: Jul. 31, 2025

(54) ENERGY STORAGE DEVICE POWER CONTUMPTION MANAGEMENT

(71) Applicant: Steffes, LLC, Dickinson, ND (US)

(72) Inventors: Paul John Steffes, Dickinson, ND (US); Austin Patrick Zeller, I, Dickinson, ND (US); Thomas Peter Steffes, Dickinson, ND (US); Kathryn Ann Harrington, Dickinson, ND (US); Brent James Kovash, Dickinson, ND (US); Todd Christopher Mayer, Dickinson, ND (US); Douglas Joseph Kadrmas, Dickinson, ND (US); Alan Jerome Takle, Dickinson, ND (US); Tabitha Christine Voytek, Dickinson, ND (US); Joshua Paul Vetter, Dickinson, ND (US)

(21) Appl. No.: 19/036,364

(22) Filed: Jan. 24, 2025

Related U.S. Application Data
(60) Provisional application No. 63/714,988, filed on Nov. 1, 2024.
(60) Provisional application No. 63/625,489, filed on Jan. 26, 2024.

(51) Int. Cl. G06F 1/28; H02J 3/00; H02J 3/28; H02J 7/00

(52) U.S. Cl. CPC G06F 1/28; H02J 3/004; H02J 3/28; H02J 7/0071

(57) ABSTRACT

In a method of managing electrical power consumption by a group of energy storage devices, each energy storage device estimates a forecasted input energy amount for a future time period and communicates the forecasted input energy amount to a system controller. The system controller calculates an aggregate input energy based on a sum of the forecasted input energy amounts, generates a charging schedule identifying a group energy consumption rate for each of a plurality of intervals of the future time period, and communicates the charging schedule to each device controller. Each device calculates a device energy consumption rate based on the corresponding forecasted input energy amount and the group energy consumption rate for each interval, and consumes electrical power based on the device energy consumption rate for the interval. A portion of the consumed electrical power is stored in the storage medium.

### CROSS REFERENCE TO RELATED APPLICATIONS

This application claims the benefit of priority from U.S. Provisional Patent Application No. 63/625,489 filed Jan. 26, 2024, entitled “Energy Storage Device Control,” and this application claims the benefit of priority from U.S. Provisional Patent Application No. 63/714,988 filed Nov. 1, 2024, entitled “Electrical Load Control,” the content of each of the above-identified provisional applications is hereby incorporated herein by reference in its entirety.

### FIELD

Embodiments of the present disclosure generally relate to methods of controlling the consumption of electrical power by energy storage devices having a storage medium in which a portion of the consumed electrical power is stored.

### BACKGROUND

For some power distribution systems, balancing power generation with energy demands (i.e., load) can be challenging, particularly when the power distribution systems are connected to electrical power generating systems having a variable power output, such as wind power generators and solar power generators. For instance, wind power generators generate electrical energy outputs that vary widely depending on the wind speeds. Additionally, the power generated by such systems cannot be easily controlled by adding or removing wind turbines responsive to the energy load on the system.

As a result, variable output power generators often generate electrical energy that exceeds the demand on the power distribution systems, such as during high wind conditions at off-peak power demand times. Such excess energy may be wasted if the load on the power distribution system is not adjusted.

For many years power distribution systems have controlled energy consuming devices through a communication that turns the devices on or off. Typically, this control is used to reduce the power demand on power distribution system peak power consumption periods, as described in U.S. Pat. No. 8,010,240. U.S. Pat. No. 8,121,742 discloses an energy distribution system that controls the activation and deactivation of a group of electrical devices (e.g., water heaters) for the purpose of controlling the load on the grid. This activation and deactivation of groups of electrical devices by the power distribution system is conducted without actual knowledge of how it may affect the energy demands placed on the power distribution system. Accordingly, control of the actual energy demand using these techniques is limited.

U.S. Pat. Nos. 8,805,597 and 10,186,879, which issued to Steffes Corporation, disclose techniques for controlling a rate of energy consumption by groups of electrical appliances, such as in response to a signal from the power distribution system. This allows the power distribution system to adjust the energy consumption of electrical appliances to meet its needs.

### SUMMARY

Embodiments of the present disclosure are directed to methods of managing electrical power consumption by a group of energy storage devices, systems and energy storage devices for implementing the method.

In some embodiments of the method of managing electrical power consumption by a group of energy storage devices, each energy storage device includes a device controller, an energy converter and a storage medium. In one embodiment of the method, each energy storage device of a group of the devices estimates a forecasted input energy amount corresponding to an anticipated amount of electrical power that will be consumed by the energy converter to add energy to the storage medium during a future time period using the device controller, and communicates the forecasted input energy amount to a system controller. The system controller calculates an aggregate input energy based on a sum of the forecasted input energy amounts, generates a charging schedule for the future time period, which identifies a group energy consumption rate for each of a plurality of intervals of the future time period, and communicates the charging schedule for the future time period to each device controller of the group of energy storage devices. Each device calculates a device energy consumption rate based on the corresponding forecasted input energy amount and the group energy consumption rate for each interval using the device controller, and consumes electrical power based on the device energy consumption rate for the interval using the energy converter. A portion of the consumed electrical power is stored in the storage medium.

Another embodiment is directed to an energy storage device that includes a storage medium, an energy converter configured to consume electrical power and store a portion of the electrical power in the storage medium, and a device controller. The device controller is configured to estimate a forecasted input energy amount corresponding to an anticipated amount of energy that will be consumed by the energy converter to add energy to the storage medium during a future time period using the device controller, communicate the forecasted input energy amount to a system controller and receive a charging schedule for the future time period, which identifies a group energy consumption rate for each of a plurality of intervals of the future time period. For each interval of the future time period, the device controller calculates a device energy consumption rate based on the corresponding input energy amount and the group energy consumption rate for the interval, and controls the energy converter to consume electrical power based on the device energy consumption rate for the interval. A portion of the consumed electrical power is stored in the storage medium.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIGS. 1 and 2 are simplified diagrams of a system in accordance with embodiments of the present disclosure.

FIG. 3 is a flowchart illustrating a method of controlling electrical power consumption from a power distribution system by a group of energy storage devices, in accordance with embodiments of the present disclosure.

FIG. 3 is a flowchart illustrating an example method of managing consumption of electrical power by a group of energy storage devices over a time period, in accordance with embodiments of the present disclosure.

FIG. 4 is a chart illustrating an estimated forecasted output energy amount and an estimated forecasted input energy amount, in accordance with embodiments of the present disclosure.

FIG. 5 is a chart illustrating an example charging schedule for a group of energy storage devices, in accordance with embodiments of the present disclosure.

FIG. 6 is a chart illustrating an example charge level of a storage medium during energy consumption by the device in accordance with a charging schedule over a time period, in accordance with embodiments of the present disclosure.

FIG. 7 is a chart illustrating a target charge schedule, in accordance with embodiments of the present disclosure.

FIG. 8 is a simplified diagram of an example controller, in accordance with embodiments of the present disclosure.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

Some embodiments of the present disclosure are directed to methods of managing electrical power consumption by energy storage devices and systems and devices for carrying out the methods. In some embodiments, the electrical energy consumption of a group of energy storage devices is controlled in a scalable manner such that tens, hundreds or even thousands of energy storage devices may be controlled in a manner that is useful to a power distribution system that supplies the electrical power to the devices while meeting the demands of users of the devices, for example.

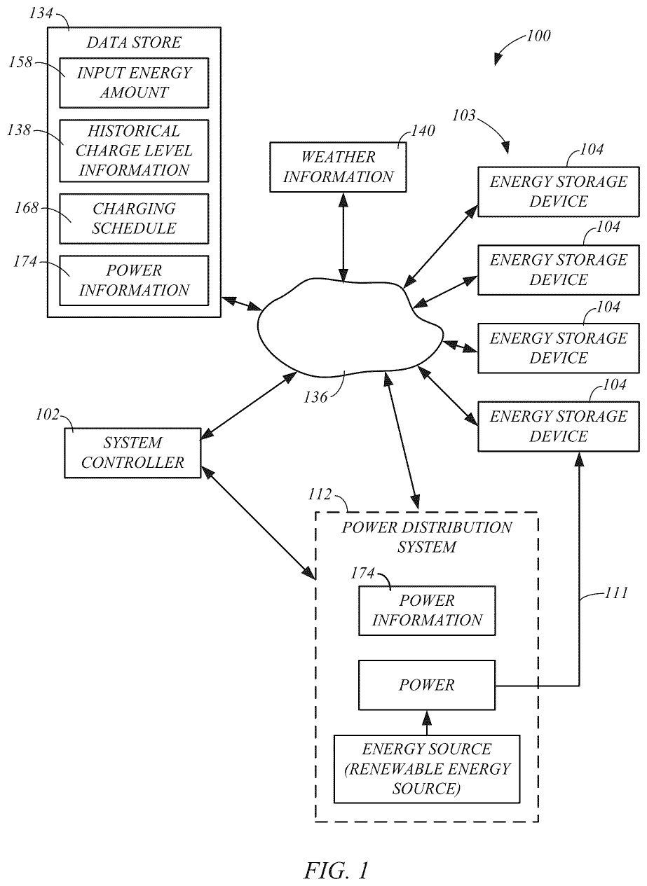

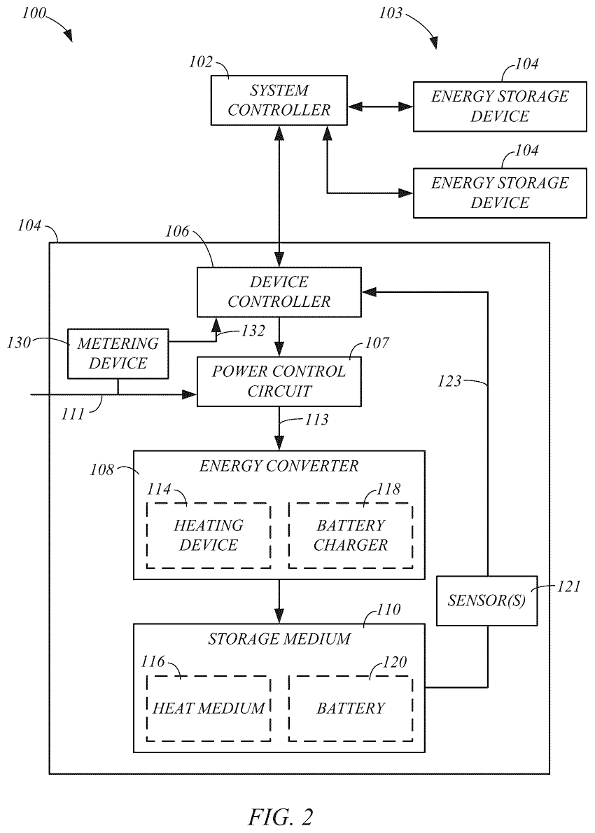

FIGS. 1 and 2 are simplified diagrams of a system 100 in accordance with embodiments of the present disclosure. The system 100 generally includes a system controller 102 and a group 103 of energy storage devices 104. In some embodiments, each energy storage device 104 includes a device controller 106, a power control circuit 107, an energy converter 108 and a storage medium 110, as shown in FIG. 2.

The devices 104 each receive electrical power 111 from a power distribution system 112, such as an electrical grid, a substation of an electrical grid, a feeder from a substation, a renewable energy source that generates electrical power from wind, solar, water, etc., a local generator, and/or another power distribution system.

In some embodiments, the power control circuit 107 (FIG. 2) delivers a portion of the power 111 received from the power distribution system 112 to the energy converter 108 in the form of a power signal 113. In some embodiments, the power signal 113 is controlled by the device controller 106 to thereby control the amount of the power 111 consumed by the device 104, such as by controlling a duty cycle of the power 113 supplied to the energy converter 108.

The energy converter 108 converts the power 113 into an energy form that is stored by the storage medium 110. In some embodiments, the energy converter 108 comprises a heating device 114 having one or more heating elements that convert the electrical energy 113 received from the power distribution system 112 into heat, which is stored in a thermal storage medium 116. The heating elements can take on any conventional form that is suited to heating the medium 116. Exemplary heating elements include resistive heating elements, such as heating coils, and other electrical heating elements.

Embodiments of the thermal storage medium 116 include liquid and solid mediums. Liquid thermal storage mediums 116 include water, oil and other conventional liquid thermal storage mediums. In some embodiments, the thermal storage medium 116 comprises a volume of water contained in a tank and the energy storage device 104 is in the form of a water heater. Examples of solid thermal storage mediums 116 include ceramic bricks, rocks, or another solid material. In one example, the energy storage device 104 is in the form of a space heater utilizing a solid thermal storage medium 116, that supplies heat to an environment, such as one or more rooms of a home or building.

In accordance with another embodiment, the energy storage devices 104 include a battery charger 118 that converts the electrical power 113 received from the power distribution system 112 into energy that is stored in a battery 120 form of the storage medium 110. The battery charger 118 and the battery 120 can be formed in accordance with conventional components. In some embodiments, the battery 120 represents one or more batteries, such as an array of batteries, or one or more batteries of an electric vehicle, for example. In some embodiments, the battery 120 is an electro-chemical battery or another conventional rechargeable battery.

In some embodiments, the storage medium 110 has a charge level corresponding to an amount of energy that is stored in the medium 110 and available for use to meet the needs of the user. For example, when the energy storage device 104 includes a thermal storage medium 116, the charge level of the medium may be determined based on a temperature of medium, and when the energy storage device includes a battery 120, the charge level of the battery may relate to a charge level of the battery 120.

In some embodiments, each device controller 106 is configured to estimate the charge level of its storage medium 110 based on one or more parameters of the storage medium 110. In one embodiment, the device includes at least one sensor 121 for sensing the one or more parameters and outputting a sensor signal 123 that is indicative of the sensed one or more parameters.

For example, when the storage medium 110 is a thermal storage medium 116, the one or more sensors 121 may include a temperature sensor that senses the temperature of the medium 116 and outputs a signal 123 that is indicative of the sensed temperature. The device controller 106 uses the sensed temperature to estimate the charge level of the medium 116 using conventional techniques, such as a known volume of the medium 116, a heat capacity of the medium 116, a coefficient of heat transfer for the medium 116, etc.

When the storage medium 110 is in the form of a battery 120, the one or more sensors 121 may include a voltage meter, a current meter, and/or another conventional device, and the sensor signal 123 may indicate a sensed voltage, current and/or another parameter, that may be used by the device controller 106 to estimate the charge level of the battery 120.

In some embodiments, the device controller 106 measures or estimates an actual output energy amount corresponding to an amount of energy that is discharged from the storage medium 110. Thus, the actual output energy amount may take the form of heat energy discharged from the thermal storage medium 116 or electrical energy discharged from the battery 120. The heat energy may be converted to an equivalent electrical energy, such as the amount of electrical energy that must be consumed by the converter 108 to store an equivalent amount of heat energy in the medium 116, for example. The actual output energy amount may be measured based on the sensed parameters indicated by the sensor signal(s) 123 from the one or more sensors 121, such as a change in the temperature of the thermal storage medium 116 or a change in the charge level of the battery 120, for example.

In some embodiments, the device controller 106 measures or estimates the actual input energy to the medium 110 by the converter 108 based on a change in the charge level of the medium 110 (e.g., temperature or battery charge level) indicated by the sensor signal(s) 123 and/or the energy consumed by the converter 108 corresponding to an electrical load provided by the device 104 on the power distribution system 112. In one embodiment, each device 104 includes a power metering device 130 (FIG. 2) that is configured to output a measured power level 132 representing a rate of electrical energy consumption. The power metering device 130 may take the form of conventional power metering devices (e.g., a power metering chip), which measure a magnitude of an electrical current, voltage and/or another parameter of the power 111 supplied to the power control circuit 107 or the power 113 supplied to the converter 108 to estimate the rate of electrical energy consumption by the energy converter 108.

In some embodiments, the device controller 106 may correlate the estimated actual input energy by the converter 118 to a change in the charge level of the storage medium. Thus, the device controller 106 may be configured to estimate the amount of electrical power that needs to be consumed by the converter to charge the storage medium 110 a particular amount.

In some embodiments, the system controller 102 and/or the device controller 106 are configured to communicate with one or more data stores 134 using conventional techniques, such as through a network 136, to store information in the data store 134 and/or retrieve information from the data store 134. The data store 134 may represent one or more databases, memory of the system controller 102, memory of the device controller 106, and/or another suitable data storage medium or memory.

In some embodiments, the charge level estimates, the actual output energy amounts, the actual input energy amounts and/or other information may be collected as historical charge level information 138 relating to the storage medium 110 of each device 104. The historical charge level information 138 may be collected using each device controller 106 and communicated to the system controller 102 and/or stored in the data store 134, as indicated in FIG. 1. The historical charge level information 138 may comprise a record of the charge level estimates, the actual output energy measurements and/or the actual input energy measurements over time, such as every minute, every 10 minutes, every hour, or another suitable time period.

In some embodiments, weather information 140, such as current weather conditions and/or forecasted weather conditions including weather parameters such as the temperature, feels-like temperature, wind conditions, solar irradiance, air quality and/or other weather related parameters, may be obtained by the device controller 106 and/or the system controller 102. Such weather information may be directly measured at or near the location of the device 104 or obtained from existing sources, such as publicly available current weather conditions and forecasted weather conditions that are accessible through the network 136, for example, as indicated in FIG. 1.

In some embodiments, the weather information 140 relating to the location of each energy storage device 104 may be obtained and stored with the corresponding historical charge level information 138, such as in association with each estimated actual output and/or input energy amount using the device controller 106 or the system controller 102. Thus, for example, an estimated charge level or actual output or input energy amount over a particular period of time on a particular date may be associated with or include one or more weather information parameters (e.g., temperature) relating to the weather at or near the location of the energy storage device 104 at or during the particular period of time and on the particular date. The resultant historical charge level information 138 may be used by the devices 104 to forecast future output and input energy amounts to manage the consumption of the power 111 supplied by the power distribution system 112.

Embodiments of the present disclosure relate to methods of managing consumption of the electrical power 111 supplied by the power distribution system 112 by a group 103 of devices over a time period. The group 103 of the devices 104 may comprise more than ten, more than one hundred, or more than one thousand, or more than ten thousand devices 104, for example.

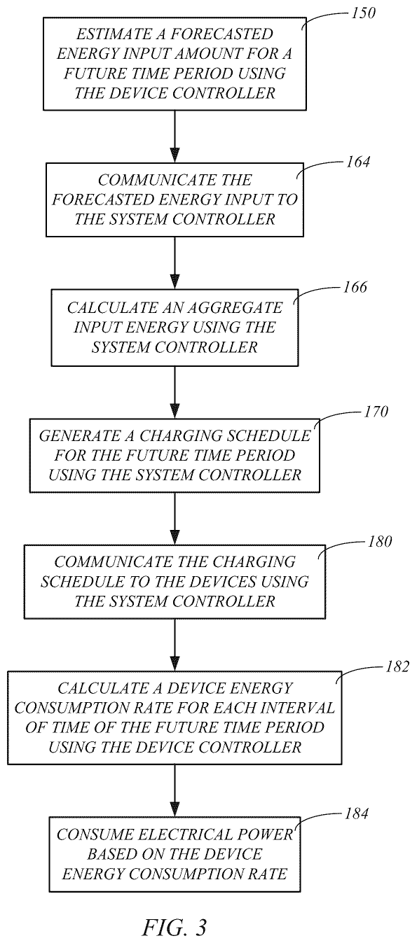

FIG. 3 is a flowchart illustrating an example of the method, in accordance with embodiments of the present disclosure. At 150 of the method, each storage device 104 estimates a forecasted input energy amount (kW or kWh) corresponding to an anticipated amount of energy (e.g., power 111) that will be consumed by the converter 108 over a future time period to meet the anticipated demands on the device 104 during the future time period, using the device controller 106. That is, the forecasted input energy amount corresponds to the energy required by the energy converter 108 to ensure that the charge level of the storage medium 108 of the device 104 is sufficient to supply an anticipated output energy amount needed for the future time period to meet user demand.

The future time period may comprise a period of 1 hour, 12 hours, 24 hours, 36 hours, or another suitable period of time in the future. The estimate of the forecasted input energy amount may occur at a predetermined period of time before the onset of the future time period, such as 12 hours, 24 hours, 36 hours or 48 hours, for example.

In some embodiments, each device controller 106 estimates its forecasted input energy amount for a future time period based on the historical charge level information 138. Since the storage device 110 may operate similarly during the future time period as it did during similar prior time periods, the device controller 106 may estimate the forecasted input energy amount based on recent actual input energy amounts from the historical charge level information 138, such as using the actual amounts from the previous day or the previous few days, and/or the actual input energy amounts relating to the same time period in the previous year or years, for example.

In some embodiments, each device controller 106 estimates the forecasted input energy amount based on a forecasted output energy amount that is anticipated to be discharged from the medium 110 during the future time period to meet user demands. The forecasted output energy amount may be determined based on recent actual output energy amounts from the historical charge level information 138, such as actual input energy amounts from the previous day or the previous few days, and/or the actual output energy amounts relating to the same time period in the previous year or years, for example.

Since each energy storage device 104 may operate similarly during periods having similar weather conditions, in some embodiments, each device controller 106 may estimate the forecasted output energy amount based on forecasted weather conditions from the weather information 140 for the future time period. For example, the device controller 106 may identify actual output energy amounts from the historical charge level information 138 corresponding to time periods having similar weather conditions as the forecasted weather conditions 140 for the future time period, and estimate the forecasted output energy amount based on the identified actual output energy amounts. While this technique for estimating the forecasted output energy amount based on the forecasted weather conditions (e.g., temperature) 140 may be best suited for the devices 104 having heating devices 114 and thermal storage mediums 116, it is understood that the technique may also be useful in estimating the forecasted input energy amount when the devices have battery chargers 118 and battery mediums 120.

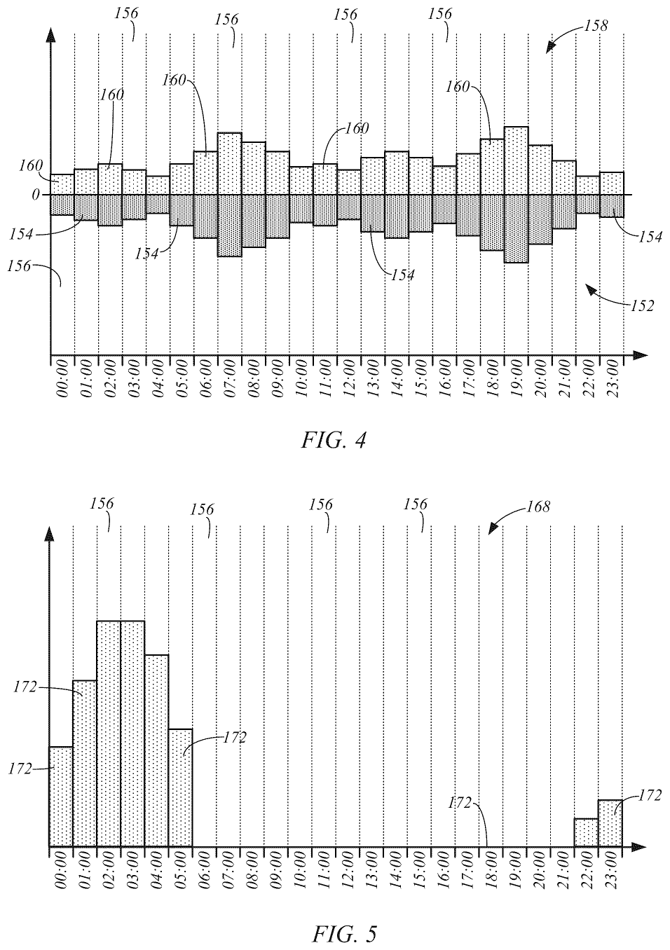

The future time period may be divided into a plurality of intervals, such as 1 minute intervals, 10 minute intervals, 30 minute intervals, 1 hour intervals, or another suitable interval. In some embodiments, each forecasted output energy amount 152 comprises a series of output energy values 154 (negative values, dark shaded bars) for each interval 156 of the future time period, as indicated in the example forecasted output energy amount 152 shown in the chart of FIG. 4 for a 24 hour future time period having 1 hour intervals 156. The output energy values 154 also generally correspond to negative changes in the charge level of the storage medium 110 from a previous state of charge of the medium 110.

In some embodiments, each device controller 106 estimates a forecasted input energy amount to meet the demand indicated by the forecasted output energy amount 152. Thus, the forecasted input energy amount 158 may comprise an input energy value 160 for each interval 156 of the future time period that generally corresponds to the output energy value 154 for the interval 156, as indicated in the example chart of FIG. 4. Each input energy value 160 generally corresponds to a positive change in the charge level of the storage medium 110 from a previous state of charge and operates to offset the output energy value 154 that is discharged from the medium during the interval 156. Accordingly, the forecasted input energy amount 158 may be used to form a device charge schedule that includes input energy values 160 for each interval 156 of the future time period that define or correspond to an amount of electrical power to be consumed by the energy converter 108 during the interval 156 to meet the output energy demands on the device 104.

At 164 of the method, each device controller 106 communicates its forecasted input energy amount 158 to the system controller 102, such as through a direct communication to the system controller 102 using a suitable data communications technique (e.g., Ethernet, radio, WiFi, cellular, etc.) and/or by storing the amount 158 in the data store 134 where it may be accessed by the system controller 106. In some embodiments, the forecasted input energy amount 158 comprises as a single value, such as the sum of the input energy values 160, and/or the forecasted input energy amount 158 may comprise the series of input energy values 160 for the intervals 156 of the future time period.

At 166 of the method, the system controller 102 calculates an aggregate input energy based on a sum of the forecasted input energy amounts 158 received from the devices 104. When the forecasted input energy amounts comprise the series of input energy values 160, the aggregate input energy may include a sum of the input energy values 160. Thus, the aggregate input energy may relate to the total anticipated energy that will be consumed by the energy converters 108 of the devices 104 during the future time period.

In some embodiments, the system controller 102 generates a charging schedule 168 (FIG. 1) that identifies a group energy consumption rate for the group of energy storage devices 104 for each of a plurality of the intervals 156 of the future time period, as indicated at 170 of the method. Thus, the charging schedule 168 identifies when the group of energy storage devices 104 should consume electrical power 111 and how much energy the devices 104 should consume using their converters 108 to charge the corresponding storage mediums 110 and meet user demands. The intervals 156 may include those mentioned above and may correspond to the intervals 156 of the input energy values 160 (if applicable). FIG. 5 is a chart illustrating an example charging schedule 168 for the group 103 identifying a group energy consumption rate 172 for each 1 hour interval over a 24 hour future time period.

In one example, the group energy consumption rate 172 for each interval 156 comprises represents either a percentage of the aggregate input energy calculated in step 166, in which a sum of the group energy consumption rates 172 for the intervals 156 totals 100%, or the group energy consumption rate 172 for each interval 156 corresponds to a portion (kWh) of the aggregate input energy calculated in step 166, in which a sum of the group energy consumption rates 172 for the intervals 156 equals the aggregate input energy.

The system controller 102 may generate the charging schedule 168 in step 170 based on various information, which may be stored in the data store 134 or another suitable data storage medium or memory. As discussed in regard to the device charging schedule (FIG. 4), the charging schedule 168 generated by the system controller 102 may be used to reduce the energy load on the power distribution system 112 during peak power consumption periods or increase the energy load on the power distribution system 112 during off-peak power consumption periods and/or when excess energy is expected to be generated from renewable energy sources, for example.

In some embodiments, the system controller 102 may generate the charging schedule 168 based on power information 174 that identifies off-peak periods of the future time period when electrical power consumption is encouraged and/or peak periods of the future time period when electrical power consumption is discouraged, such as using pricing information for the power 111 (e.g., cost per kWh), for example. The power information 174 may be obtained from the data store 134 or another source by the system controller 102, communicated to the system controller 102 from the power distribution system 112, or obtained by the system controller 102 in another manner. Thus, the charging schedule 168 may direct the energy storage devices 104 to consume power during times that differ from the forecasted input or output energy amounts (FIG. 4), such as during early morning hours and/or late evening hours (e.g., off-peak hours) and avoid consuming power during daytime hours (e.g., on-peak hours), as indicated in the example charging schedule 168 shown in FIG. 5. In some embodiments, the system controller 102 generates the charging schedule 168 based on weather information 140, and/or other information, that may be obtained by the system controller 102, such as from the data store 134 or another source.

At 180 of the method, the system controller 102 communicates the charging schedule 168 to the group 103 of energy storage devices 104 one or multiple times in advance of the future time period. The system controller 102 may issue the communication using a suitable communication technique, such as a wired or wireless communication (Ethernet, Wi-Fi, cellular, radio, etc.). In one embodiment, the system controller 102 broadcasts the communications using a radio broadcast, such as in accordance with the Advance Television Systems Committee 3.0 standard, an FM sideband, or another suitable broadcast communication technique.

The communication of the charging schedule 168 may include a group identifier that may be used to direct the communication to a particular group 103 of the devices 104, such as when more than one group of the devices 104 is within the broadcast range of the system controller 102. This allows the system controller 102 to target individual groups of the devices 104, such that only the device controllers 106 of the identified group of the devices 104 use the communicated charging schedule 168 in controlling their energy consumption.

At 182 of the method, each energy storage device 104 calculates a device energy consumption rate based on the corresponding forecasted input energy amount 158 and the group energy consumption rate 172 for the interval 156 using the device controller 106.

The calculation of the device energy consumption rate by the device controller 106, as well as the calculation of the forecasted energy input and other calculations, offloads the significant processing that would otherwise be required to be performed by the system controller 102, and facilitates scaling of the system for groups 103 of hundreds, thousands or tens of thousands of the devices 104. Such scaling would be significantly more complicated if the system controller 106 was required to handle each calculation in step 182, the estimation in step 150, etc., as well as the communications of individual device energy consumption rates to the devices 104. Thus, embodiments of the method improve the functioning of the system controller 102 and reduce congestion of data communication paths, while simplifying the ability of the system 100 to work with a large number of energy storage devices 104.

When the group energy consumption rate 172 comprises a percentage of the aggregate input energy calculated in step 166, the device energy consumption rate may be calculated by multiplying the group energy consumption rate 172 for the interval 156 by the forecasted input energy amount 158. Thus, for example, when the forecasted input energy amount 158 for one of the devices 104 is 40 kWh, the calculated device energy consumption rates for each interval 156 may be calculated by multiplying the group energy consumption rate 172 of the interval by 40 kWh.

When the charging schedule 168 communicated to the devices 104 includes the aggregate energy amount and the group energy consumption rates 172 for each interval 156 are portions (kWh) of the aggregate input energy calculated at step 166, the device energy consumption rate for each interval 156 may be calculated by the device controller 106 by multiplying the energy portion indicated by the rate 172 for each interval 156 by a ratio of the forecasted energy input amount (kWh) 158 to the aggregate input energy (kWh). Thus, when the forecasted input energy amount 158 for one of the devices is 40 kWh, and the aggregate input energy is 100 kWh, the device controller calculates the device energy consumption rates for each interval 156 by multiplying the group energy consumption rate 172 (kWh) for an interval by 0.4.

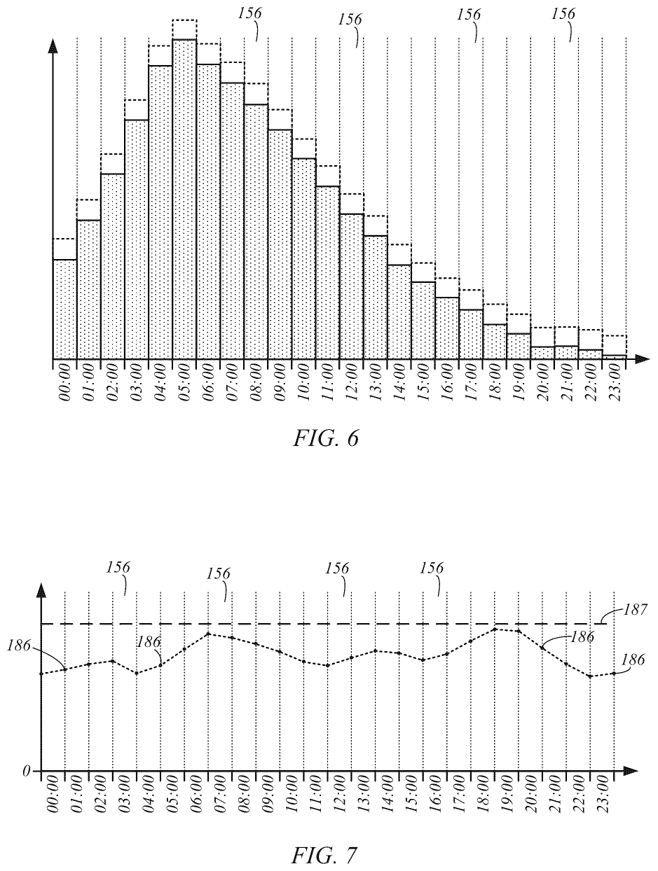

Starting at the beginning of the future time period, each device 104 consumes electrical power (power 111, power 113) during each interval 156 of the future time period using its energy converter 108 based on the calculated device energy consumption rate for the interval 156, as indicated at 184 of the method. A portion of the energy consumed during each interval 156 by each device 104 is stored in the storage medium 110 of the device 104, which increases the charge level of the medium 110. For example, during the future time period, as a device 104 charges the medium 110 due to the performance of step 184 and discharges energy from the medium 110 to satisfy user demand, the charge level of the medium may change over the future time period as indicated in the chart of FIG. 6.

As a result, the group 103 of energy storage devices 104 may operate to consume sufficient electrical power to meet the demands of the user while also assisting the power distribution system 112 by time-shifting electrical loads from peak power consumption periods to off-peak power consumption periods through charging of the storage medium 110 during off-peak periods and using the stored energy to meet user needs during on-peak power consumption periods, for example.

The method may be repeated in a similar manner for subsequent future time periods.

In some embodiments, the device controller 106 monitors the actual input energy amount corresponding to the amount of energy consumed by the converter during step 184, such as using the metering device 130 and/or the sensor output(s) 123, the actual output energy amount discharged from the medium 110, such as using the sensor output(s) 123, and/or the charge level of the medium 110 using the sensor output(s) 123, and logs the information as the historical charge level information 138 in the data store 134. This information 138 may be used to estimate the forecasted input energy amount 152 and forecasted output energy amounts 158 for future time periods, as mentioned above. In some embodiments, the power distribution system 112 accesses at least some of this information 138, such as the actual input energy amounts, and/or receives a communication with this information from the device controller 106 or the system controller 102, such as through the network 136.

While the forecasted energy output and input amounts may provide a reasonable estimate of the charge level of the medium 110 that is required to meet user demand during the future time period, the actual user demand during the future time period may require higher or lower input and output energy amounts. When the actual user demand is lower than expected (e.g., lower output energy amount), consuming electrical power according to the charging schedule 168 issued by the system controller 102 in step 180 may result in overcharging of one or more of the storage mediums 110. For example, when a storage medium 110 comprises a thermal storage medium 116 and the energy output amount discharged from a prior time period or during step 184 is less than anticipated, the medium 116 may exceed a maximum temperature if the charging schedule was followed during step 184. Additionally, when the actual user demand is higher than expected (e.g., higher output energy amount), consuming electrical power according to the charging schedule 168 during step 184 may result in undercharging of the medium 110, which could deplete the stored energy in the medium 110 and prevent the device from meeting user demands.

Some embodiments of the present disclosure operate to prevent the overcharging or undercharging of the medium 110 in step 184 of the method, or to promote maximum charging of the medium during step 184 of the method. In one embodiment, the device controller 106 adds an offset or correction factor to the device energy consumption rate, such as to the device energy consumption rate 172 of individual intervals 156, that boosts the input energy to the medium, as indicated in phantom lines in FIG. 6. The offset may be selected by the device controller based on the state of charge of the storage medium 110 at the beginning of the future time period or during one or more intervals 156.

In one embodiment, each device controller 106 generates a target charge schedule 185, which is shown in the chart of FIG. 7, for the future time period that generally defines a minimum charge level 186 (dots) of the medium 110 at the beginning or end of each interval 156 of the future time period and/or a maximum charge level 187 for the medium 110 during the future time period. The target charge schedule 185 for the medium 110 may generally correspond to estimated forecasted output energy amount 152 or input energy amount 158 shown in FIG. 4.

During step 184, the device controller 106 controls the converter 108 to consume electrical power based on a combination of the charging schedule 168 issued by the system controller 102 and the target charge schedule 185. For example, if the charge level of the medium 110 reaches the maximum charge level 187 defined by the target charge schedule 185 during step 184, the device controller 106 may deactivate the converter 108 to avoid further charging of the medium 110.

When the charge level of the medium 110 at the onset or during an interval is above the target minimum charge level 186 at the end of the interval 156 defined by the target charge schedule 185, the device controller 106 controls the converter 108 to consume electrical power during step 184 accordance with the charge schedule 168 issued by the system controller 102 by consuming electrical power during the interval 156 based on the device energy consumption rate for the interval 156.

When the charge level of the medium 110 at the onset of an interval 156 is below the target minimum charge level 186 set for the end of the interval 156 and the device energy consumption rate 172 for the interval 156 will not result in the charging of the medium 110 to the target minimum charge level 186 by the end of the interval 156, the device controller 106 may increase the device energy consumption rate such that the minimum target charge level 186 is reached by the end of the interval 156. As a result, in some embodiments, the device controller 106 can prevent undercharging of the medium 110, which could prevent the device from meeting user demand.

In some embodiments, each device controller 106 avoids stark (e.g., stepwise) increases or decreases in the device energy consumption rate while following the charging schedule 168 during step 184 or when attempting to achieve the minimum target charge level 186 by the end of an interval 156 by gradually increasing or decreasing the device energy consumption rate at the beginning of an interval 156 from the device energy consumption rate of the prior interval 156. As a result, rapid changes in the electrical load on the power distribution system 112 by the group 103 of devices 104 may be avoided or at least reduced. This may be accomplished by ramping or spline fitting a desired device energy consumption rate starting at the beginning of a next interval 156 from the device energy consumption rate at the end of the prior interval 156, for example.

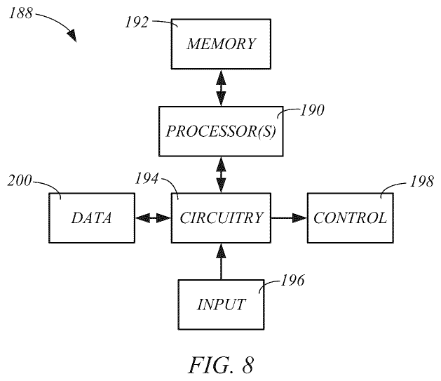

The system controller 102 and the device controller 106 of each device 104 may take on any suitable form. An example of a suitable controller 188 that may be used to form the system controller 102 or the device controller 106 is shown in the simplified diagram of FIG. 8. The controller 188 may include one or more processors 190 and memory 192, which may be local memory or memory that is accessible to the controller 188. The one or more processors 190 are configured to perform various functions described herein in response to the execution of instructions contained in the memory 192, for example.

The one or more processors 180 may be components of one or more computer-based systems, and may include one or more control circuits, microprocessor-based engine control systems, and/or one or more programmable hardware components, such as a field programmable gate array (FPGA). The memory 192, including the data store 134, represents any suitable patent subject matter eligible computer-readable media and does not include transitory waves or signals. Examples of the memory 192 include conventional data storage devices, such as hard disks, CD-ROMs, optical storage devices, magnetic storage devices and/or other suitable data storage devices or computer-readable media.

The controller 188 may include circuitry 194 for use by the one or more processors 190 to receive input signals 196 (e.g., sensor outputs, conditions, data communications), issue control signals 198 (e.g., control signals 132) and/or communicate data 200, such as in response to the execution of the instructions stored in the memory 192 by the one or more processors 190.

Although the present invention has been described with reference to preferred embodiments, workers skilled in the art will recognize that changes may be made in form and detail without departing from the spirit and scope of the present disclosure. For example, the devices 104 may take on other forms other than the heating and battery charging devices described herein.

What is claimed is:

1. A method of managing electrical power consumption by a group of energy storage devices, each energy storage device comprising a device controller, an energy converter and a storage medium, the method comprising:
for each energy storage device:
estimating a forecasted input energy amount corresponding to an anticipated amount of electrical power that will be consumed by the energy converter to add energy to the storage medium during a future time period using the device controller; and
communicating the forecasted input energy amount to a system controller using the device controller;
calculating an aggregate input energy based on a sum of the forecasted input energy amounts using the system controller;
generating a charging schedule for the future time period using the system controller, the charging schedule identifying a group energy consumption rate for each of a plurality of intervals of the future time period;
communicating the charging schedule for the future time period to each device controller of the group of energy storage devices using the system controller; and
for each energy storage device:
calculating a device energy consumption rate based on the corresponding forecasted input energy amount and the group energy consumption rate for each interval using the device controller; and
during each interval of the future time period, consuming electrical power based on the device energy consumption rate for the interval using the energy converter and storing a portion of the consumed electrical power in the storage medium.

2. The method according to claim 1, wherein each of the forecasted input energy amounts comprises a series of input energy values each corresponding to an estimated amount of energy that will be consumed by the energy converter during one of the intervals, or each of the forecasted input energy amounts comprises a sum of the series of the input energy values.

3. The method according to claim 1, wherein:
each energy storage device is configured to log historical charge level information relating to prior operations of the energy storage device; and
estimating the forecasted input energy amount for each energy storage device comprises estimating the forecasted input energy amount based on the logged historical charge level information usage data.

4. The method according to claim 3, wherein the historical charge level information includes one or more actual input energy amounts, each corresponding to a measured or an estimated amount of energy that was actually consumed by the energy converter during a prior period of time.

5. The method according to claim 4, wherein each of the actual input energy amounts are each associated with at least one weather condition occurring around the prior period of time corresponding to the actual input energy amount.

6. The method according to claim 1, wherein:
the group energy consumption rate for each interval comprises a percentage of the aggregate input energy; and
for each interval and for each energy storage device, calculating the device energy consumption rate comprises multiplying the group energy consumption rate for the interval by the forecasted input energy amount.

7. The method according to claim 1, wherein:
the charging schedule comprises the aggregate input energy; and
for each energy storage device, calculating the device energy consumption rate for each interval comprises multiplying the group energy consumption rate for the interval by a ratio of the forecasted input energy amount for the interval to the aggregate input energy.

8. The method according to claim 1, wherein the method includes, for each energy storage device:
generating a target charge schedule for the future period of time comprising a target charge level for the storage medium at the end of each of interval of the time period using the device controller; and
consuming electrical power comprises consuming electrical power during each interval based on the target charge level for the storage medium at the end of the interval.

9. The method according to claim 1, wherein the method includes generating the charging schedule using the system controller based on the aggregate input energy.

10. The method according to claim 9, wherein generating the charging schedule comprises generating the charging schedule based on at least one of a communication from a power distribution system that supplies the electrical power and weather information.

11. The method according to claim 1, wherein in each of the energy storage devices:
the storage medium comprises a liquid or solid thermal storage medium, and the energy converter comprises a heating device that stores the portion of the consumed electrical power as thermal energy in the thermal storage medium; or
the storage medium comprises a battery, and the energy converter comprises a battery charger that stores the portion of the consumed electrical power in the battery.

12. An energy storage device comprising:
a storage medium;
an energy converter configured to consume electrical power and store a portion of the electrical power in the storage medium; and
a device controller configured to:
estimate a forecasted input energy amount corresponding to an anticipated amount of energy that will be consumed by the energy converter to add energy to the storage medium during a future time period using the device controller;
communicate the forecasted input energy amount to a system controller;
receive a charging schedule for the future time period, which identifies a group energy consumption rate for each of a plurality of intervals of the future time period;
for each interval of the future time period, calculate a device energy consumption rate based on the corresponding input energy amount and the group energy consumption rate for the interval; and
during each interval of the future time period, control the energy converter to consume electrical power based on the device energy consumption rate for the interval, wherein a portion of the consumed electrical power is stored in the storage medium.

13. The energy storage device according to claim 12, wherein the forecasted input energy amount comprises a series of input energy values each corresponding to an estimated amount of energy that will be consumed by the energy converter during one of the intervals, or a sum of the series of the input energy values.

14. The energy storage device according to claim 12, wherein the device controller is configured to:
log historical charge level information relating to prior operations of the energy storage device; and
estimate the forecasted input energy amount based on the logged historical charge level information.

15. The energy storage device according to claim 14, wherein the historical charge level information includes:
one or more charge levels of the storage medium at prior periods of time;
one or more forecasted input energy amounts for prior periods of time; and/or
one or more estimated actual input energy amounts, each corresponding to a measured or an estimated amount of energy that was actually consumed by the energy converter or stored in the storage medium during a prior period of time.

16. The energy storage device according to claim 12, wherein the device controller is configured to calculate the device energy consumption rate according to a method comprising multiplying the group energy consumption rate for the interval by the forecasted input energy amount.

17. The energy storage device according to claim 12, wherein:
the charging schedule comprises an aggregate input energy; and
the device controller is configured to calculate the device energy consumption rate according to a method comprising multiplying the group energy consumption rate for the interval by a ratio of the forecasted input energy amount for the interval to the aggregate input energy.

18. The energy storage device according to claim 12, wherein: device controller is configured to:
generate a target charge schedule for the future period of time comprising a target charge level for the storage medium at the end of each of interval of the time period; and
control the electrical converter to consume electrical power during each interval based on the target charge level for the storage medium at the end of the interval.

19. The energy storage device according to claim 12, wherein:
the storage medium comprises a liquid or solid thermal storage medium and, the energy converter comprises a heating device that stores the portion of the consumed electrical power as thermal energy in the thermal storage medium; or
the storage medium comprises a battery, and the energy converter comprises a battery charger that stores the portion of the consumed electrical power in the battery.
